(19) United States
(12) Patent Application Publication
(10) Pub. No.: US 2026/0364593 A1
(43) Pub. Date: Nov. 19, 2026

(54) TIP FOR SAMPLING PIPETTE

(71) Applicants: GILSON SAS, VILLIERS-LE-BEL (FR); UNIVERSITÉ CLERMONT AUVERGNE, CLERMONT-FERRAND (FR); CENTRE NATIONAL DE LA RECHERCHE SCIENTIFIQUE, PARIS Cedex 16 (FR); CLERMONT AUVERGNE INP, AUBIERE Cedex (FR)

(72) Inventor: Nicolas BATISSE, PERIGNAT LES SARLIEVE (FR)

(21) Appl. No.: 19/121,312

(22) PCT Filed: Sep. 22, 2023
(86) PCT No.: PCT/FR2023/051460

§ 371 Date: Apr. 15, 2025

(30) Foreign Application Priority Data
Oct. 18, 2022 (FR) FR2210760

(51) Int. Cl. B01L 3/02

(52) U.S. Cl. CPC B01L 3/0275; B01L 2200/12

(57) ABSTRACT

A pipette tip including at least one wall portion having a conical shape of revolution with axis, characterized in that the wall portion includes at least one first partition extending on a circumference of at least a part of an inner surface, the first partition extending as a protrusion from a base in contact with the inner surface to a top at an angle of between 40°and 140°with respect to the wall portion.

### CROSS REFERENCE TO RELATED APPLICATIONS

This application is a National Stage of International Application No. PCT/FR2023/051460, having an International Filing Date of 22 Sep. 2023, which designated the United States of America, and which International Application was published under PCT Article 21(2) as WO Publication No. 2024/084146, which claims priority from and the benefit of French Patent Application No. 2210760 filed on 18 Oct. 2022, the disclosures of which are incorporated herein by reference in their entireties.

### BACKGROUND

### Field

The disclosure lies in the field of sampling pipettes, also called laboratory pipettes or liquid transfer pipettes, for sampling and dispensing a sample of a liquid in containers or the like.

More particularly, the disclosure relates to a pipette tip, adapted for manually actuated pipettes, motorized pipettes, or pipetting robots.

### Brief Description of Related Developments

For many years, the design of pipettes with manual, motorized or automatic actuation (also called pipetting systems) has been the object of many improvements aiming to simplify their design, minimize the implementation costs, or improve their operation.

One of the conventional issues in the field of pipettes is the flow of the liquid inside the pipette in order to optimize the sampling and dispensing operations, while minimizing the contaminations between the various samples.

Thus, it is known to develop solutions related to consumables for pipettes, and in particular to the tip, in order to maximize the ratio between the liquid sampled and the liquid dispensed in order to not distort samples, limit the losses of liquid, and limit the contaminations between the various samples.

The known solutions involve chemical surface treatments on the tip after its manufacturing by plastic injection or surface topological texturing before or after the manufacturing of the tip by plastic injection so as to lower the surface energy of the polymer, a component material of the sampling tip, and thus limit the liquid retained in the sampling tip by the inner walls.

However, such surface treatments, even if they can be effective from a static physics point of view, do not take into account the aspects relating to the flow dynamics of the liquid at the interface with the solid during the two critical phases constituted by the aspiration of the liquid into the sampling tip and the dispensing of the liquid from the sampling tip.

Indeed, a surface can have hydrophobic, superhydrophobic, oleophobic or superoleophobic characteristics under static measurement conditions, but can be hydrophilic, superhydrophilic, oleophilic or superoleophilic under conditions of use, in the state immersed by liquid present in the pipette tip.

Maintaining a “Cassie-Baxter” state so that the drops of liquid remain at the top of the roughness of a treated surface during a dynamic movement of the liquid is therefore difficult to achieve due to these characteristics variable according to the static or dynamic mode.

To counteract this problem, it is known to implement tips having conical walls with inner surfaces locally comprising peaks and hollows.

However, a disadvantage of these inner surfaces carrying deformations is that the liquid, during its movement, can easily penetrate and wet the hollows of the texture because of the Wenzel state, that is to say the ease of adaptation and wetting to the morphology of the surface.

Furthermore, this state, observed on flat surfaces, is all the more exacerbated when the pressure exerted by the fluid on the surface is strong, which is typically the case of a liquid confined in a space having a small diameter such as the tip.

There is therefore a need to improve such tips for pipettes in order to improve the flow of the liquid during aspiration and dispensing and better control the flow rate of the liquid, whether to retain it or accelerate it.

### SUMMARY

The goal of the disclosure is to at least partly overcome the disadvantages mentioned above relating to the techniques of the prior art.

To do this, the disclosure relates to a pipette tip, comprising at least one wall having a conical shape of revolution with axis R. According to the disclosure, the wall portion comprises, on at least a part of an inner surface, at least one first partition extending as a protrusion from a base in contact with said inner surface to a top at an angle of between 40° and 140° with respect to said wall.

Thus, the disclosure proposes a novel and inventive approach allowing to at least partly solve some of the disadvantages of the prior art by the fact that the tip has, on at least a part of an inner surface of a portion of a conical wall, a microtextured surface with protrusions allowing to trap pockets of air near the deformations, and thus the liquid circulating in the tip is at least partially in contact with air and not entirely with the walls of the tip. As a result, the interactions between the liquid and the partitions of the tip are limited and, consequently, the risks of retention of liquid on the inner surface of the partition of the tip are limited. As a result, a tip having a wall portion that is hydrophobic or even super hydrophobic, or oleophobic or even super oleophobic, in dynamic flow is obtained.

Moreover, this also allows to be able to better control the flow rate by braking, or accelerating, the liquid.

According to one aspect of at least one aspect of the disclosure, the at least one first partition extends over the entire perimeter of the inner surface of the wall portion.

In this case, according to one aspect of at least one aspect of the disclosure, the at least one first partition can have a circular shape, that is to say form a circle on a circumference of the inner surface of the wall portion.

According to another aspect of at least one aspect of the disclosure, the tip can comprise, on at least a part of an inner surface of said wall, several partitions forming a plurality of circles spaced apart longitudinally, over the length of the tip.

According to another aspect of at least one aspect of the disclosure, the tip can comprise a partition forming a spiral on the inner surface of the tip, along a longitudinal axis of the tip.

According to one aspect of at least one aspect of the disclosure, said at least one first partition has a height h between said base and said top, smaller than 80 μm, preferably between 1 μm and 50 μm, more preferably between 5 μm and 20 μm.

According to one aspect of at least one aspect of the disclosure, said at least one first partition has a first width at the location of said base of between 1 μm and 20 μm, and a second width at the location of said top of between 0.1 μm and 10 μm.

In this way, this makes it possible to implement a partition that can have various shapes.

For example, this allows to implement a partition having a triangular shape allowing to facilitate the removal from the mold during the creation of the tip. This further allows to implement various triangular shapes according to the uses.

It is also possible to provide a partition having a rounded shape at the top.

According to one aspect of at least one aspect of the disclosure, the tip has a plurality of first partitions, the top S of each of the first partitions being spaced apart from the top S of an adjacent partition by a distance of less than 200 μm, preferably between 10 μm and 80 μm. Furthermore, the tip comprises at least one channel, each channel being defined by the spacing between two first partitions.

Such a spacing is large enough for air to be able to be trapped between first two partitions.

According to a specific aspect of at least one aspect, the tip comprises, on at least a part of an inner surface of said wall portion, a plurality of second partitions extending as a protrusion from a base in contact with said inner surface to a top along generatrixes of the tip, said second partitions intersecting said first partitions, thus forming a plurality of cavities, each cavity being defined by the intersection between two adjacent first partitions and two adjacent second partitions.

According to a specific aspect of at least one aspect, said first partitions are distributed over the circumference of said inner surface of said wall portion and said second partitions are distributed over the circumference of said inner surface of said wall portion, each of the cavities comprising a volume of between 100 μm³ and 3200*10³μm³.

According to a specific aspect of at least one aspect, said first partitions are distributed uniformly over the circumference of said inner surface of said wall portion and said second partitions are distributed uniformly over the circumference of said inner surface of said wall portion, each of the cavities having a uniform volume of between 100 μm³ and 3200*10³μm³.

The disclosure also relates to a pin for an injection mold configured for the molding by plastic injection of a pipette tip according to one of the aforementioned aspects, said pin comprising a wall portion having a conical shape of revolution with axis R including, on at least one first conical section of an outer surface, at least one first groove hollowed out from said outer surface to a bottom at an angle of between 40 and 140° with respect to said outer surface, on the circumference of the outer surface.

According to a specific aspect of at least one aspect, said pin comprises at least one second groove hollowed out from said outer surface to a bottom along generatrixes of the pin.

The disclosure also relates to a method for manufacturing a pin for an injection mold according to one of the aforementioned aspects, the method comprising a step of forming at least one groove by micro-spark erosion, by laser, by micro-milling, by ion beam, or by 3D printing.

The disclosure also relates to a method for manufacturing a pipette tip according to one of the aforementioned aspects, by plastic injection using a plastic injection mold carrying at least one conical pin according to one of the aforementioned aspects.

### BRIEF DESCRIPTION OF THE DRAWINGS

The disclosure, as well as the various advantages it has, will be more easily understood in the light of the following description of an illustrative and non-limiting aspect thereof, and the appended drawings among which:

FIG. 1 is a perspective view of a pipette according to an aspect of the disclosure;

FIG. 2 is a perspective view of a pipette tip according to an aspect of the disclosure;

FIG. 3 is a lateral cross-sectional view of the tip of FIG. 2;

FIG. 4a is another lateral cross-sectional view of the tip of FIG. 2;

FIG. 4b is a detailed view of a part of the tip of FIG. 4a;

FIG. 4c is a detailed view of a part of the tip of FIG. 4b;

FIG. 5 is a detailed view of a part of the tip of FIG. 4c;

FIG. 6 is a detailed view of a part of a tip according to a second aspect;

FIG. 7 is a detailed view of a cavity according to the aspect of FIG. 6;

FIG. 8a is a view of a pin according to a first aspect of the disclosure;

FIG. 8b is a detailed view of a part of the pin of FIG. 8a;

FIG. 9a is a view of a pin according to a second aspect of the disclosure, and

FIG. 9b is a detailed view of a part of the pin of FIG. 9a.

### DETAILED DESCRIPTION

The general principle of the disclosure is based on the implementation of non-occasional protrusions on a circumference of at least a part of an inner surface of the wall of a pipette tip so as to maintain a “Cassie-Baxter” state, and thus so that the drops of liquid remain at the top of the protrusions during a dynamic movement of the liquid.

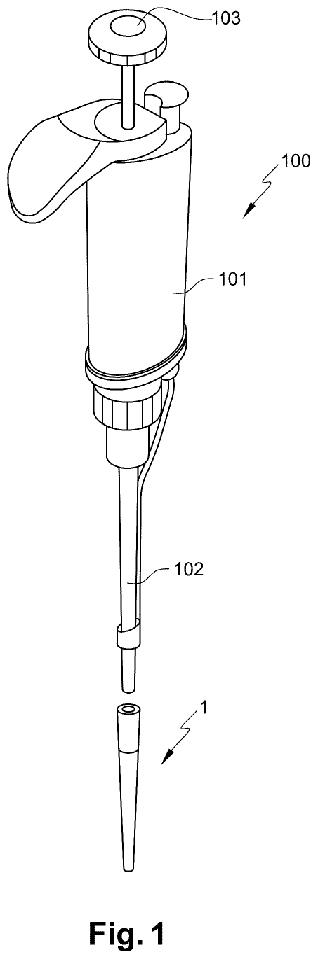

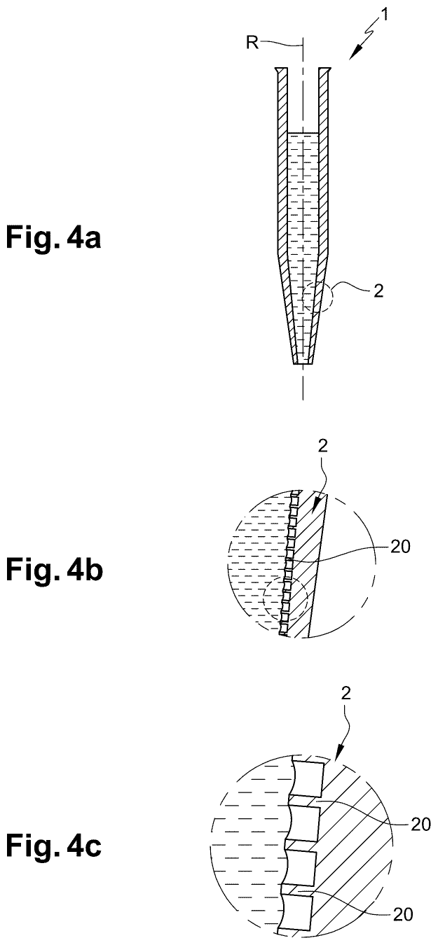

A first aspect of the disclosure is now presented, in relation to FIGS. 1 to 5.

Manual pipettes are intended to be held in the hand by an operator, during the operations of sampling and dispensing liquid. For mechanical manual pipettes, these operations are carried out by movement of a pipetting control button, obtained by the application of an actuation pressure onto this same button which is mechanically transferred to a control rod. On motorized pipettes, the control pressure of the operator on the control button engenders a signal that is transmitted to the control unit of the pipette, in order for the latter to trigger the movement of the control rod via a motor on board the pipette.

As for pipetting robots, they are placed on the bench of the laboratory and a control system engenders the signal that is transmitted to the control unit of the robot, in order for the latter to trigger the movement of the pipetting unit via a motor.

It should be noted that pipettes, whether manual, motorized, or automatic, can be air displacement or positive displacement pipettes. Positive displacement pipettes are used with tips of the syringe type where the liquid is in direct contact with the piston. In this case, the piston is part of the tip and is discarded after use.

For the case of air displacement pipettes, the liquid is never in contact with the piston, which is located inside the lower part of the pipette, in the tip holder. FIG. 1 illustrates a mechanical manual air displacement pipette 100 having a body 101 above which there is a pipetting control button 103. The body 101 is extended by a pipetting head 102 carrying, at its end, a tip 1.

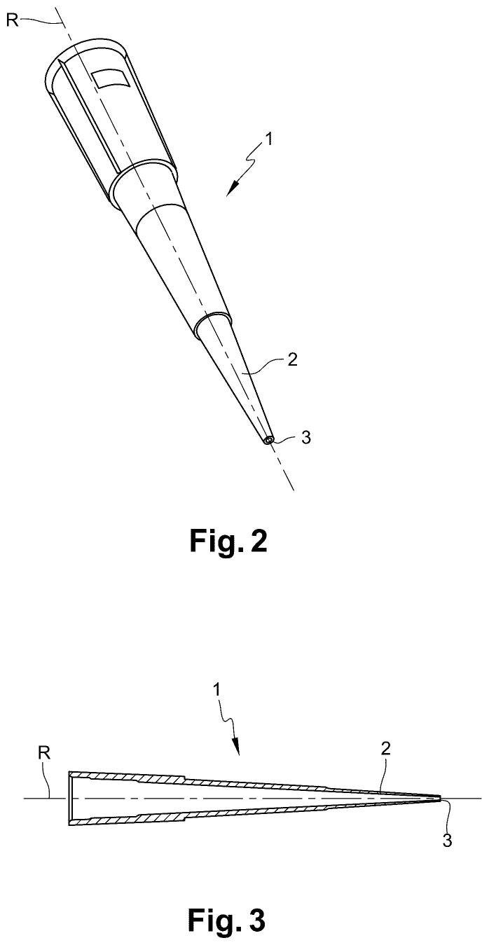

According to the disclosure, the tip, illustrated more particularly in FIGS. 2 to 6, comprises a wall portion 2 having a conical shape of revolution with axis R.

More particularly, this wall portion has a cross-section decreasing towards an end 3 for outlet of the liquid from the pipette.

According to other aspects, the entirety of the wall of the tip could have a conical shape.

The wall portion 2 of the tip 1 includes an outer surface, and an inner surface intended to be in contact with liquid sampled or to be dispensed.

According to the disclosure, the tip 1 comprises at least one first partition 20 extending over a circumference of at least a part of the inner surface of the wall portion 2.

This first partition 20 extends as a protrusion from a base 200 in contact with the inner surface to a top 201 at an angle of between 40° and 140° with respect to the wall portion 2.

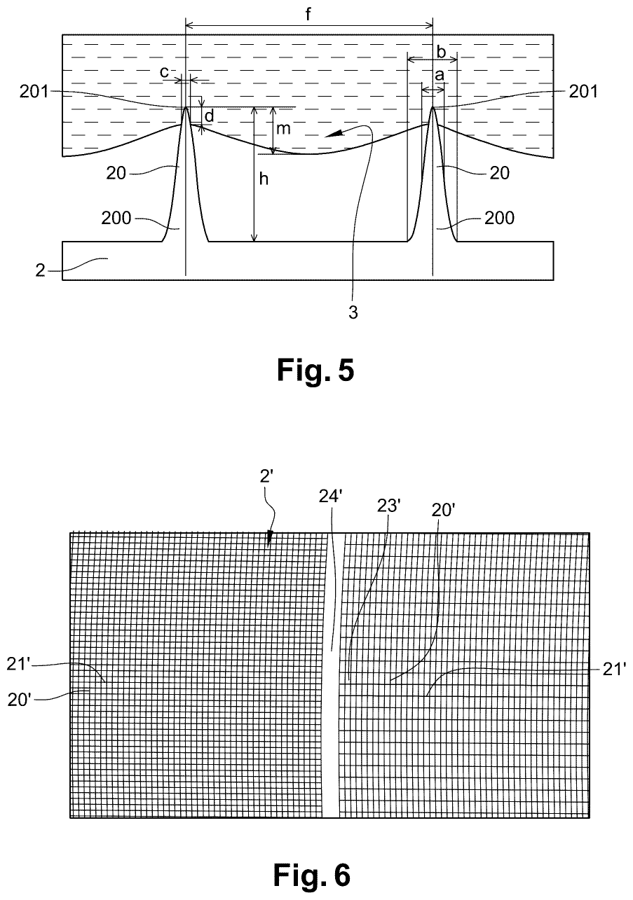

In the aspect illustrated, and as visible in particular in FIG. 5, the first partition 20 extends as a protrusion from a base 200 in contact with the inner surface of the wall portion 2 to a top 201 at an angle substantially equal to 90° with respect to the wall 2.

Thus, such a pipette tip 1 allows to trap pockets of air near the first partition 20, and thus the liquid circulating in the tip is at least partially in contact with air and not entirely with the inner surface of the tip. As a result, the interactions between the liquid and the walls of the tip are limited and, consequently, the risks of retention of liquid on the inner surface of the wall portion 2 of the tip 1 are limited.

In the aspect illustrated, the inner surface of the wall portion 2 comprises several first partitions 20, two being shown in FIG. 5.

In the aspect, illustrated, each of the first partitions 20 has a height h between the base 200 and the top 201 of between 5 μm and 20 μm.

In general, each of the first partitions has a height, between the base and the top, of less than 80 μm, preferably between 1 μm and 50 μm.

Furthermore, in the aspect, illustrated, each of the first partitions 20 has a first width b of between 1 μm and 20 μm, and a second width c at the location of the top 201 of between 0.01 μm and 10 μm.

Furthermore, in the aspect illustrated, each of the first partitions 20 has a third width at mid-height a, corresponding to a height at 0.5 h, of between 0.1 b and 0.6 b.

Therefore, in this aspect, the first partitions have a substantially triangular profile.

The advantage of having such a shape for the first partitions is that during manufacturing, for example by plastic injection molding, the operations of removal from the mold are facilitated.

According to other aspects, it is possible for the first partitions to have a rectangular, or trapezoidal, shape.

Each of these first partitions 20 extends over the entire perimeter of the inner surface of the wall portion 2, and has a circular shape.

In this manner, and due to the conical shape of the wall portion, the inner surface has a plurality of first partitions spaced apart longitudinally and forming circles of various diameters on the inner surface of the wall portion 2.

The longitudinal spacing f between two first partitions can be considered as the spacing between two tops 201 of two adjacent first partitions, and can preferably be between 10 μm and 80 μm.

Furthermore, between two first partitions, the tip comprises at least one channel, each channel being defined by the spacing between two first partitions 20.

In general, the top 201 of each of the first partitions 20 is spaced apart from the top 201 of an adjacent partition by a distance of less than 200 μm.

Furthermore, such a longitudinal spacing f allows the liquid, during a dynamic movement, to come in contact with the first partitions and soak a height d of the first partitions, while avoiding coming in contact with the inner surface of the wall portion 2. This longitudinal spacing thus allows to have a height m between the top 201 of the partition and the bottom of the meniscus that is less than 0.99 h.

In other words, the liquid meniscus forming between two partitions has a height m smaller than the height h so as to not touch the inner surface of the wall portion 2.

According to an alternative of this aspect, the tip could comprise a single first partition forming a spiral on the inner surface of the tip, along a longitudinal axis of the tip.

According to another alternative of this aspect, the tip could comprise several portions of first partitions aligned at the same height of the circumference of the inner surface of the tip.

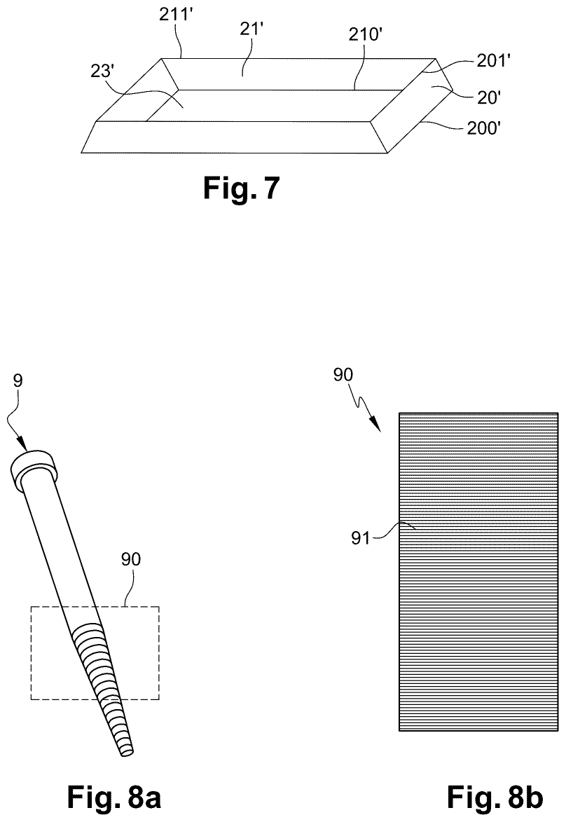

A second aspect of the disclosure is now presented, in relation to FIGS. 6 and 7.

In this aspect, the pipette tip 1′ comprises a wall portion 2′ having a conical shape of revolution with axis R, with, like for the first aspect, several first partitions 20′ extending over a circumference of a part of an inner surface of the partition 2′, the first partition extending as a protrusion from a base in contact with the inner surface to a top at an angle of between 40° and 140° with respect to the partition 2′.

In this second aspect, the tip further comprises, on at least a part of an inner surface of the wall portion 2′, a plurality of second partitions 21′ extending as a protrusion from a base 210′ in contact with the inner surface to a top 211′ along generatrixes of the tip, these second partitions intersecting the first partitions 20′.

Thus, the tip comprises a plurality of cavities 23′, each cavity being defined by the intersection between two adjacent first partitions 20′ and two adjacent second partitions 21′.

In this second aspect, the first partitions 20′ are not distributed uniformly over the circumference of the inner surface of the wall portion 2′ and the second partitions 21′ are distributed uniformly over the circumference of the inner surface of the wall 2′. A central band 24′ remains devoid of any partition.

Here, each of the cavities 23′ comprises a substantially equal volume of between 100 μm³ and 3,200*10³ μm³.

According to other aspects, the first partitions 20′ could be distributed uniformly over the circumference of the inner surface of the wall portion 2′ and/or the second partitions could be distributed uniformly over the circumference of the inner surface of the partition 2′.

A first aspect of a pin for an injection mold configured for the plastic injection molding of a pipette tip 1 is now presented in relation to FIGS. 8a and 8b. As illustrated, this pin comprises a wall portion having a conical shape of revolution with axis R including, on at least one first section 90 of an outer surface, at least one first groove 91 hollowed out from the outer surface to a bottom at an angle of between 40 and 140° with respect to the outer surface, on the circumference of the outer surface.

More particularly, in this aspect, this pin comprises a plurality of first grooves 91 hollowed out from the outer surface to a bottom at an angle of between 40 and 140° with respect to the outer surface.

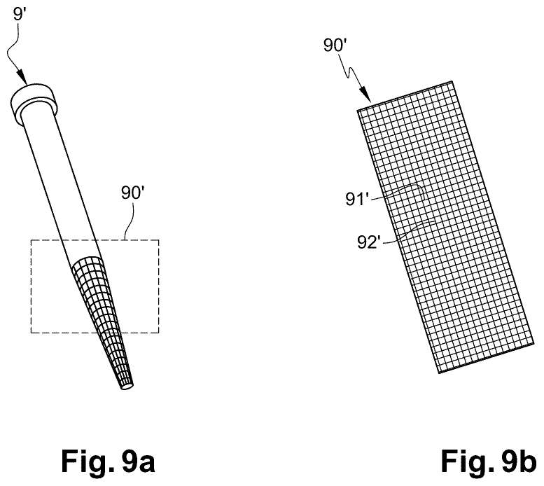

A second aspect of a pin for an injection mold configured for the plastic injection molding of a pipette tip 1 is now presented in relation to FIGS. 9a and 9b. As illustrated, this pin 9′ comprises a wall portion having a conical shape of revolution with axis R including, on at least one first section 90′ of an outer surface, at least one first groove 91′ hollowed out from the outer surface to a bottom at an angle of between 40 and 140° with respect to the outer surface, on the circumference of the outer surface.

More particularly, in this aspect, this pin comprises a plurality of first grooves 91′ hollowed out from the outer surface to a bottom at an angle of between 40 and 140° with respect to the outer surface.

Furthermore, the pin of this second aspect comprises on at least one first conical section of an outer surface at least one second groove 92′ hollowed out from the outer surface to a bottom at an angle of between 40 and 140° with respect to the outer surface, along generatrixes of the pin.

More particularly, in this second aspect, the pin comprises a plurality of second grooves 92′ hollowed out from said outer surface to a bottom along generatrixes of the pin.

Such a pin according to one of the aspects described above allows to implement a method for manufacturing a pipette tip by plastic injection using a plastic injection mold comprising at least one pin.

It should be noted that this pin for an injection mold can be manufactured via a method comprising a step of forming at least one groove by micro-spark erosion, by laser, by micro-milling, by ion beam, or by 3D printing.

What is claimed is:

1. A pipette tip comprising at least one wall portion having a conical shape of revolution with axis, said wall portion comprising a plurality of first partitions, each extending on a circumference of at least a part of an inner surface, each of said first partitions extending as a protrusion from a base in contact with said inner surface to a top at an angle of between 40° and 140° with respect to said wall portion, the top of each of said first partitions being spaced apart from the top of an adjacent partition by a distance of less than 200 μm, preferably between 10 μm and 80 μm, said tip comprising at least one channel, each channel being defined by the spacing between two first partitions, characterized in that said tip comprises, on at least a part of an inner surface of said wall portion, a plurality of second partitions extending as a protrusion from a base in contact with said inner surface to a top along generatrixes of said tip, said second partitions intersecting said first partitions, said tip comprising a plurality of cavities, each cavity being defined by the intersection between two adjacent first partitions and two adjacent second partitions.

2. The pipette tip according to claim 1, characterized in that each of said first partitions extends over the entire perimeter of said inner surface of said wall portion.

3. The pipette tip according to claim 1, characterized in that each of said first partitions has a height, between said base and said top, of less than 80 μm, preferably between 1 μm and 50 μm, more preferably between 5 μm and 20 μm.

4. The pipette tip according to claim 1, characterized in that each of said first partitions has a first width at the location of said base of between 1 μm and 20 μm, and a second width at the location of said top of between 0.01 μm and 10 μm.

5. The pipette tip according to claim 1, characterized in that said first partitions are distributed over the circumference of said inner surface of said wall portion and said second partitions are distributed over the circumference of said inner surface of said wall portion, each of the cavities comprising a volume of between 100 μm³ and 3200*10³ μm³.

6. A pin for an injection mold configured for the plastic injection molding of a pipette tip according to claim 1, characterized in that said pin comprises at least one wall portion having a conical shape of revolution with axis including, on at least one first conical section of an outer surface, at least one first groove hollowed out from said outer surface to a bottom at an angle of between 40 and 140° with respect to said outer surface, on the circumference of the outer surface.

7. The pin according to claim 6, configured for the plastic injection molding of a pipette tip, the pipette tip comprising at least one wall portion having a conical shape of revolution with axis, said wall portion comprising a plurality of first partitions, each extending on a circumference of at least a part of an inner surface, each of said first partitions extending as a protrusion from a base in contact with said inner surface to a top at an angle of between 40° and 140° with respect to said wall portion, the top of each of said first partitions being spaced apart from the top of an adjacent partition by a distance of less than 200 μm, preferably between 10 μm and 80 μm, said tip comprising at least one channel, each channel being defined by the spacing between two first partitions, characterized in that said tip comprises, on at least a part of an inner surface of said wall portion, a plurality of second partitions extending as a protrusion from a base in contact with said inner surface to a top along generatrixes of said tip, said second partitions intersecting said first partitions, said tip comprising a plurality of cavities, each cavity being defined by the intersection between two adjacent first partitions and two adjacent second partitions;
the pin being characterized in that said pin comprises at least one second groove hollowed out from said outer surface to a bottom along generatrixes of the pin.

8. A method for manufacturing a pin for an injection mold according to claim 6, characterized in that it comprises a step of forming at least one groove by micro-spark erosion, by laser, by micro-milling, by ion beam, or by 3D printing.

9. The method for manufacturing a pipette tip by plastic injection using a plastic injection mold, the pipette tip comprising at least one wall portion having a conical shape of revolution with axis, said wall portion comprising a plurality of first partitions, each extending on a circumference of at least a part of an inner surface, each of said first partitions extending as a protrusion from a base in contact with said inner surface to a top at an angle of between 40° and 140° with respect to said wall portion, the top of each of said first partitions being spaced apart from the top of an adjacent partition by a distance of less than 200 μm, preferably between 10 μm and 80 μm, said tip comprising at least one channel, each channel being defined by the spacing between two first partitions, characterized in that said tip comprises, on at least a part of an inner surface of said wall portion, a plurality of second partitions extending as a protrusion from a base in contact with said inner surface to a top along generatrixes of said tip, said second partitions intersecting said first partitions, said tip comprising a plurality of cavities, each cavity being defined by the intersection between two adjacent first partitions and two adjacent second partitions;
and the plastic injection mold comprising at least one pin, for the plastic injection mold, for the plastic injection molding of the pipette tip, the at least one pin characterized in that said pin comprises at least one wall portion having a conical shape of revolution with axis including, on at least one first conical section of an outer surface, at least one first groove hollowed out from said outer surface to a bottom at an angle of between 40 and 140° with respect to said outer surface, on the circumference of the outer surface.
